(19) United States
(12) Patent Application Publication
(10) Pub. No.: US 2025/0199284 A1
(43) Pub. Date: Jun. 19, 2025

(54) IMAGE FORMATION LENS AND MICROSCOPE DEVICE

(71) Applicant: NIKON CORPORATION, Tokyo (JP)

(72) Inventor: Hidetsugu TAKAGI, Yokohama-shi (JP)

(73) Assignee: NIKON CORPORATION, Tokyo (JP)

(21) Appl. No.: 18/859,266

(22) PCT Filed: Apr. 10, 2023
(86) PCT No.: PCT/JP2023/014513

§ 371 Date: Oct. 23, 2024

(30) Foreign Application Priority Data
Apr. 25, 2022 (JP) 2022-071566

(51) Int. Cl. G02B 21/04; G02B 7/02; G02B 15/14; G02B 27/00

(52) U.S. Cl. CPC G02B 21/04; G02B 7/021; G02B 7/025; G02B 15/143105; G02B 27/0062

(57) ABSTRACT

An image formation lens (IL) for a microscope comprises: a negative lens; and a positive lens (L13) that satisfies the following conditional expression:

$$- 0.002 \times ( ν dP - 35 ) + 0.602 - θ gFP < 0$$

$$23 < ν dP < 65$$

where vdP: an Abbe number of the positive lens, and θgFP: a partial dispersion ratio of the positive lens that is defined by the following expression: θgFP=(ngP−nFP)/(nFP−nCP) where ngP is a refractive index of the positive lens to a g-line, nFP is a refractive index of the positive lens to an F-line, and nCP is a refractive index of the positive lens to a C-line.

### CROSS REFERENCE TO RELATED APPLICATIONS

This application is a U.S. National Stage Application which claims the benefit under 35 U.S.C. § 371 of International Patent Application No. PCT/JP2023/014513 filed on Apr. 10, 2023, which claims priority benefit from Japanese Patent Application No. 2022-071566 filed on Apr. 25, 2022, the contents of each of which are incorporated herein by reference.

### TECHNICAL FIELD

The present invention relates to an image formation lens and a microscope device.

### TECHNICAL BACKGROUND

In recent years, various image formation lenses for microscopes have been proposed which can be applied to objective lenses with a wide field of view (see, for example, Patent Literature 1). Such image formation lenses are required to sufficiently correct chromatic aberration.

### PRIOR ARTS LIST

### Patent Document

Patent literature 1: Japanese Patent No. 6397717

### SUMMARY OF THE INVENTION

An image formation lens according to a first aspect of the present invention is an image formation lens for a microscope that forms an image of light from an objective lens, comprising: a negative lens; and a positive lens that satisfies the following conditional expression:

$$- 0.002 \times ( ν dP - 35 ) + 0.602 - θ gFP < 0$$

$$23 < ν dP < 65$$

where vdP: an Abbe number of the positive lens, and
θgFP: a partial dispersion ratio of the positive lens that is defined by the following expression:

$$θ gFN = ( ngP - nFP ) / ( nFP - nCp )$$

where ngP is a refractive index of the positive lens to a g-line, nFP is a refractive index of the positive lens to an F-line, and nCP is a refractive index of the positive lens to a C-line.

An image formation lens according to a second aspect of the present invention is an image formation lens for a microscope that forms an image of light from an objective lens, comprising: a positive lens; and a negative lens that satisfies the following conditional expression:

$$- 0.0033 \times ( ν dN - 35 ) + 0.593 - θ gFN < 0$$

$$20 < ν dN < 37$$

where vdN: an Abbe number of the negative lens, and
θgFN: a partial dispersion ratio of the negative lens that is defined by the following expression:

$$θ gFN = ( ngN - nFN ) / ( nFN - nCN )$$

where ngN is a refractive index of the negative lens to g-line, nFN is a refractive index of the negative lens to an F-line, and nCN is a refractive index of the negative lens to a C-line.

A microscope device according to the present invention comprises: an objective lens that receives light from an object and converts the light into a parallel light; and one of the above image formation lens.

### BRIEF DESCRIPTION OF THE DRAWINGS

FIG. 1 is a sectional view showing the configuration of an image formation lens according to a first example;

FIG. 2 shows various aberration diagrams of the image formation lens according to the first example;

FIG. 3 is a chromatic aberration diagram of the image formation lens according to the first example;

FIG. 4 is a coma aberration diagram of the image formation lens according to the first example;

FIG. 5 is a sectional view showing the configuration of an image formation lens according to a second example;

FIG. 6 shows various aberration diagrams of the image formation lens according to the second example;

FIG. 7 is a chromatic aberration diagram of the image formation lens according to the second example;

FIG. 8 is a coma aberration diagram of the image formation lens according to the second example;

FIG. 9 is a sectional view showing the configuration of an image formation lens according to a third example;

FIG. 10 shows various aberration diagrams of the image formation lens according to the third example;

FIG. 11 is a chromatic aberration diagram of the image formation lens according to the third example;

FIG. 12 is a coma aberration diagram of the image formation lens according to the third example;

FIG. 13 is a sectional view showing the configuration of an image formation lens according to a fourth example;

FIG. 14 shows various aberration diagrams of the image formation lens according to the fourth example;

FIG. 15 is a chromatic aberration diagram of the image formation lens according to the fourth example;

FIG. 16 is a coma aberration diagram of the image formation lens according to the fourth example;

FIG. 17 is a sectional view showing the configuration of an image formation lens according to a fifth example;

FIG. 18 shows various aberration diagrams of the image formation lens according to the fifth example;

FIG. 19 is a chromatic aberration diagram of the image formation lens according to the fifth example;

FIG. 20 is a coma aberration diagram of the image formation lens according to the fifth example; and

FIG. 21 is a schematic configuration view showing a confocal fluorescence microscope as an example of the microscope device.

### DESCRIPTION OF THE EMBODIMENTS

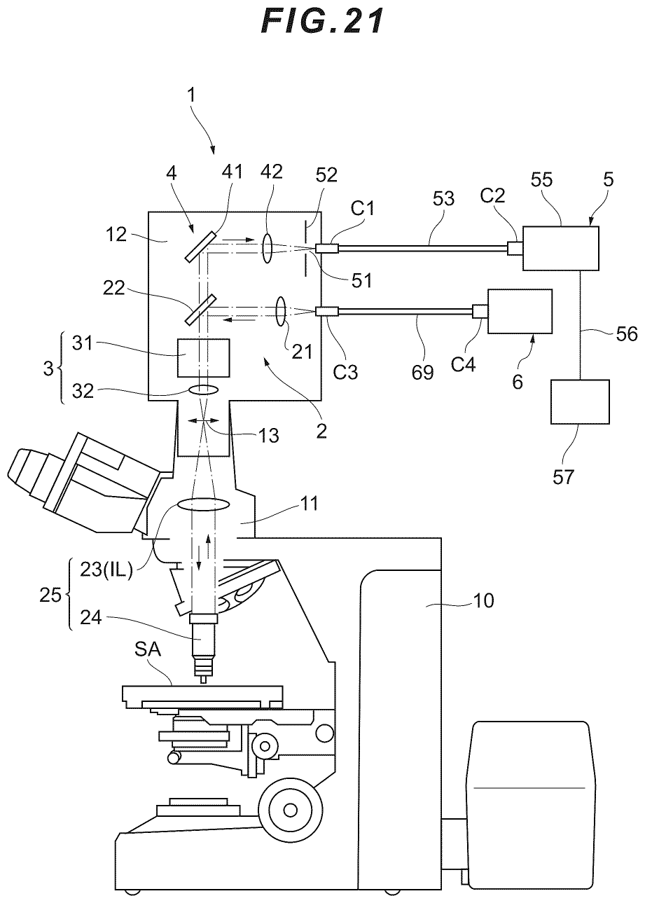

Hereinafter, preferred embodiments according to the present invention will be described. First, a confocal fluorescence microscope (microscope device) comprising an image formation lens according to each embodiment is explained based on FIG. 21. As shown in FIG. 21, the confocal fluorescence microscope 1 comprises an excitation light introducing part 2 that directs laser light for illumination from a light source unit 6 onto a sample SA, a scanning device 3 that deflects the laser light condensed on the sample SA and scans the laser light on the sample SA, a photodetector 5 that detects a light intensity signal from the sample SA, and a collective optical system 4 that directs the light from the sample SA to the photodetector 5.

The light source unit 6 may be provided in the confocal fluorescence microscope 1 or be separated from the confocal fluorescence microscope 1. The light source unit 6 comprises a laser light source (not shown), a beam diameter adjusting mechanism (not shown), and the like. The light source unit 6 oscillates the laser light for illumination.

The excitation light introducing part 2 comprises a collimator lens 21, a dichroic mirror 22, and a microscope optical system 25 including an image formation lens 23 and an objective lens 24. The collimator lens 21 and the dichroic mirror 22 are arranged inside a microscope housing part 12 provided above a lens barrel part 11 in a microscope body 10. Here, the light source unit 6 and the microscope housing part 12 are connected through an optical fiber 69 using connectors C3 and C4. The collimator lens 21 converts the laser light (flux of light) oscillated from the light source unit 6 into parallel light. The dichroic mirror 22 reflects the laser light from the collimator lens 21 toward the sample SA. The microscope optical system 25 condenses the laser light reflected by the dichroic mirror 22 onto the sample SA by using the image formation lens 23 and the objective lens 24. The image formation lens 23 is arranged inside the lens barrel part 11 in the microscope body 10. The image formation lens 23 is also referred to as a second objective lens. The objective lens 24 is attached to a lower part of the lens barrel part 11.

The scanning device 3 comprises a scanning mechanism (scanner) 31 and a scanning optical system 32. The scanning device 3 is arranged between the dichroic mirror 22 and the image formation lens 23 inside the microscope housing part 12. The scanning mechanism (scanner) 31 comprises, for example, a galvanic mirror (not shown) or a resonant mirror (not shown). The scanning mechanism (scanner) 31 deflects incoming laser light. In other words, the scanning mechanism (scanner) 31 deflects the laser light that is condensed onto the sample SA and scans the laser light on the sample SA. The scanning optical system 32 is an optical system provided between the scanning mechanism (scanner) 31 and the image formation lens 23. The scanning optical system 32 is an optical system in which a focal position of the scanning optical system 32 is located on an image formation surface 13 (also referred to as a primary image surface) conjugate with the sample SA (scanning surface of the sample SA).

The collective optical system 4 comprises the objective lens 24 and the image formation lens 23 that constitute the microscope optical system 25, a total reflection mirror 41, and a condenser lens 42. The objective lens 24 receives fluorescent light generated in the sample SA and converts the fluorescent light into parallel light. The image formation lens 23 initially condenses the fluorescent light (parallel light) that is emitted from the objective lens 24 onto the image formation surface 13 (primary image surface) and forms an image of the fluorescent light. As a result, the fluorescent light, coming from the sample SA and passing through the objective lens 24 and the image formation lens 23, is initially condensed onto the image formation surface 13, and reaches the total reflection mirror 41 through the scanning device 3 and the dichroic mirror 22. The total reflection mirror 41 and the condenser lens 42 are arranged above the dichroic mirror 22 inside the microscope housing part 12. The total reflection mirror 41 reflects the fluorescent light coming from the sample SA and passing through the objective lens 24 and the image formation lens 23. The condenser lens 42 condenses the fluorescent light reflected by the total reflection mirror 41 onto a light shielding panel 52 having a pinhole 51 (aperture).

The photodetector 5 comprises the light shielding panel 52 having the pinhole 51, an optical fiber 53, and a detection unit 55. The optical fiber 53 is connected to the microscope housing part 12 and the detection unit 55 using connectors C1 and C2. The light (fluorescent light) that has passed through the pinhole 51 enters the optical fiber 53. The detection unit 55 detects the light (fluorescent light) that has passed through the pinhole 51 and the optical fiber 53. The detection unit 55 is electrically connected to a processing unit 57 via a cable 56. The processing unit 57 performs image processing (of the sample SA) based on a detection detected by the detection unit 55, and an observation image of the sample SA obtained by image processing of the processing unit 57 is displayed on a monitor not shown.

Here, the laser light from the scanning device 3 is initially condensed onto the image formation surface 13 (primary image surface) and the image formation lens 23 and the objective lens 24 of the microscope optical system 25 are configured to condense the light again onto the sample SA. In other words, the scanning surface of the sample SA, the image formation surface 13, and the pinhole 51 are in conjugate relation with each other. Therefore, when the image formation lens 23 and the objective lens 24 are configured to condense light onto the sample SA, it becomes possible to pass the fluorescent light generated on the scanning surface of the sample SA, among the light (fluorescent light) coming from the sample SA, through the pinhole 51.

Although the confocal fluorescence microscope 1 has been described as an example of the microscope device according to the present embodiment, the present embodiment is not limited to this. For example, the microscope device according to the present embodiment may be a multi-photon excitation microscope, a super-resolution microscope, or the like. The confocal fluorescence microscope 1 may be an upright microscope or an inverted microscope.

As the image formation lens 23 provided for the confocal fluorescence microscope 1 (microscope device), an image formation lens IL described below can be used. First, the image formation lens IL according to the first embodiment will be described.

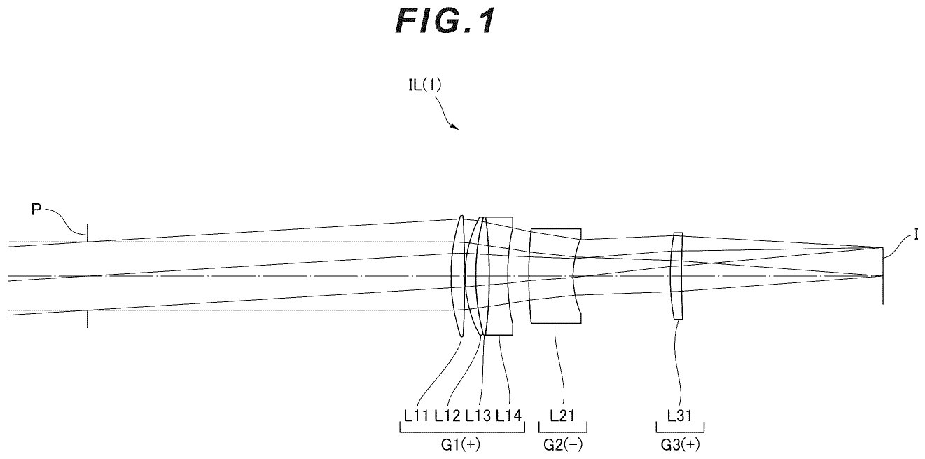

As an example of the image formation lens IL according to the first embodiment, an image formation lens IL (1) shown in FIG. 1 comprises a negative lens and a positive lens (L13) that satisfies the following conditional expression (1) and the conditional expression (2):

$$- 0.002 \times ( vdP - 35 ) + 0.602 - θ gFP < 0 \qquad ( 1 )$$

$$3 < vdP < 65 \qquad ( 2 )$$

where vdP: an Abbe number of the positive lens, and θgFP: a partial dispersion ratio of the positive lens that is defined by the following expression:

$$θ gFP = ( ngP - nFP ) / ( nFP - nCP )$$

where ngP is a refractive index of the positive lens to a g-line, nFP is a refractive index of the positive lens to an F-line, and nCP is a refractive index of the positive lens to a C-line.

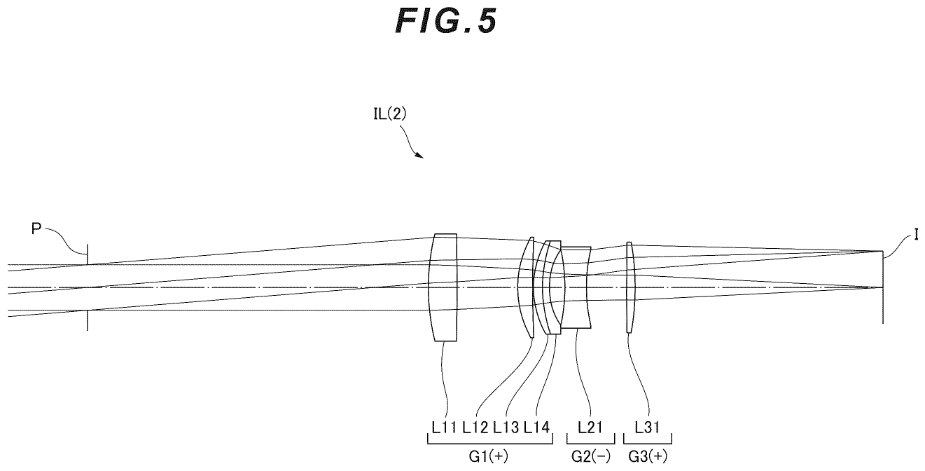

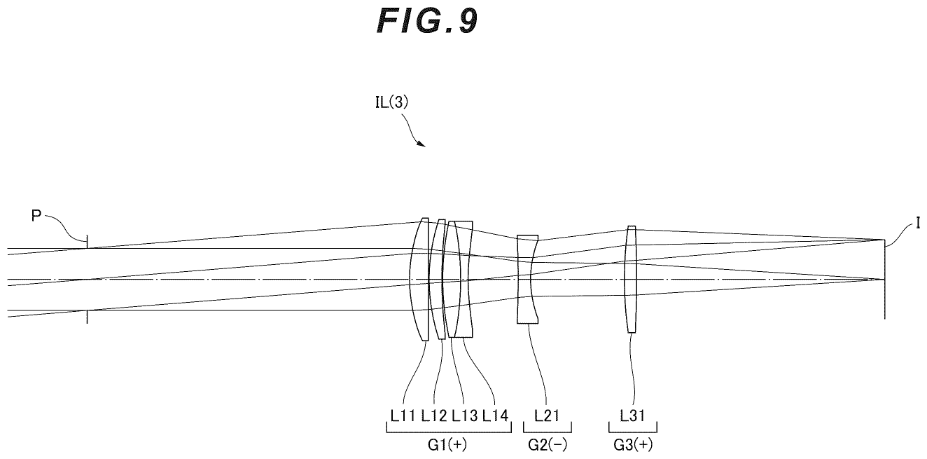

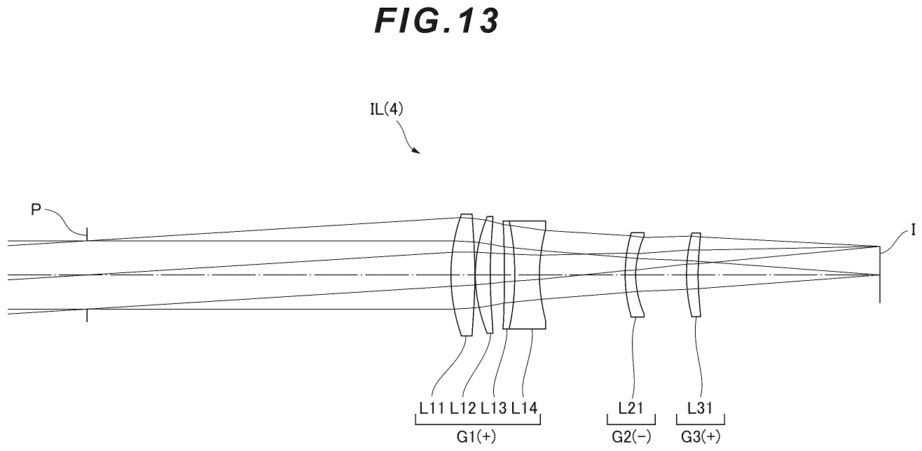

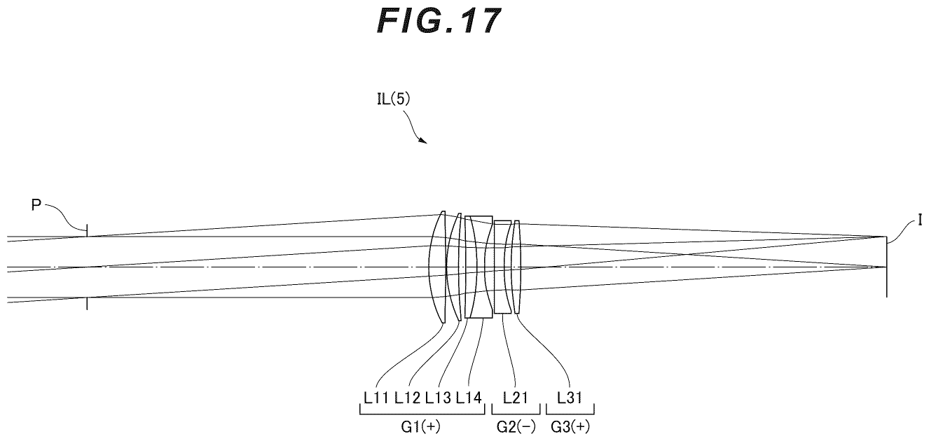

According to the first embodiment, it becomes possible to obtain an image formation lens having chromatic aberration sufficiently corrected in a wide wavelength range and a microscope device comprising the image formation lens. The image formation lens IL according to the first embodiment may be an image formation lens IL (2) shown in FIG. 5, an image formation lens IL (3) shown in FIG. 9, an image formation lens IL (4) shown in FIG. 13, or an image formation lens IL (5) shown in FIG. 17.

The conditional expression (1) appropriately defines anomalous dispersion characteristics of the positive lens. By satisfying the conditional expression (1), a secondary spectrum of longitudinal chromatic aberration can be corrected sufficiently.

When a corresponding value of the conditional expression (1) is out of the above range, it becomes difficult to correct the secondary spectrum of the longitudinal chromatic aberration. The effect of the present embodiment can be made more reliable by setting an upper limit of the conditional expression (1) to −0.002 and further to −0.004. It is also possible to set a lower limit of the conditional expression (1) to −0.05 and further to −0.025.

The conditional expression (2) defines an appropriate range of the Abbe number of the positive lens. By satisfying the conditional expression (2), a primary longitudinal chromatic aberration can be corrected sufficiently.

When a corresponding value of the conditional expression (2) is out of the above range, it becomes difficult to correct the primary longitudinal chromatic aberration. The effect of the present embodiment can be made more reliable by setting an upper limit of the conditional expression (2) to 60, 55, 50, 45, 40, and further to 35. The effect of the present embodiment can be made more reliable by setting a lower limit of the conditional expression (2) to 23.5, 24, and further to 24.5.

In the image formation lens IL according to the first embodiment, the positive lens may satisfy the following conditional expression (3):

$$1.55 < ndP < 1 \text{.79} \qquad ( 3 )$$

where ndP: a refractive index of the positive lens to a d-line.

The conditional expression (3) defines an appropriate range of the refractive index of the positive lens to the d-line. By satisfying the conditional expression (3), curvature of field can be corrected sufficiently.

When a corresponding value of the conditional expression (3) exceeds an upper limit, the difference in refractive index between the positive lens and a lens next to the positive lens increases, which makes it difficult to correct spherical aberration. The effect of the present embodiment can be made more reliable by setting the upper limit of the conditional expression (3) to 1.78 and further to 1.76.

When the corresponding value of the conditional expression (3) exceeds a lower limit, the refractive index of the positive lens to the d-line decreases, and the term relating to the positive lens in petzval sum increases, which makes it difficult to correct the curvature of field. The effect of the present embodiment can be made more reliable by setting the lower limit of the conditional expression (3) to 1.58 and further to 1.60.

In the image formation lens IL according to the first embodiment, the positive lens may satisfy the following conditional expression (4):

$$0.4 < fP / f < 1.2 \qquad ( 4 )$$

where fP: a focal length of the positive lens, and
f: a focal length of the image formation lens.

The conditional expression (4) defines an appropriate relationship between the focal length of the positive lens and the focal length of the image formation lens IL. By satisfying the conditional expression (4), a secondary spectrum of longitudinal chromatic aberration can be corrected sufficiently.

When a corresponding value of the conditional expression (4) exceeds an upper limit, refracting power of the positive decreases, which makes it difficult to correct the secondary spectrum of the longitudinal chromatic aberration. The effect of the present embodiment can be made more reliable by setting the upper limit of the conditional expression (4) to 1.15 and further to 1.1.

When the corresponding value of the conditional expression (4) falls below a lower limit, the refracting power of the positive lens increases, and thereby the secondary spectrum of the longitudinal chromatic aberration is excessively corrected, which makes it difficult to sufficiently correct the secondary spectrum of the longitudinal chromatic aberration. The effect of the present embodiment can be made more reliable by setting the lower limit of the conditional expression (4) to 0.41 and further to 0.42.

Now, the image formation lens IL according to a second embodiment is described. Since the image formation lens IL according to the second embodiment is similar in configuration to the image formation lens IL according to the first embodiment, description is given by using characters identical to those in the first embodiment.

As an example of the image formation lens IL according to the second embodiment, the image formation lens IL (1) shown in FIG. 1 comprises a positive lens and a negative lens (L21) that satisfies the following conditional expression (5) and conditional expression (6):

$$- 0.0033 \times ( vdN - 35 ) + 0.593 - θ gFN < 0 \qquad ( 5 )$$

$$20 < vdN < 37 \qquad ( 6 )$$

where vdN: an Abbe number of the negative lens, and θgFN: a partial dispersion ratio of the negative lens that is defined by the following expression:

$$θ gFN = ( ngN - nFN ) / ( nFN - nCN )$$

where ngN is a refractive index of the negative lens to a g-line, nFN is a refractive index of the negative lens to an F-line, and nCN is a refractive index of the negative lens to a C-line.

According to the second embodiment, it becomes possible to obtain an image formation lens having chromatic aberration sufficiently corrected in a wide wavelength range and a microscope device comprising the image formation lens. The image formation lens IL according to the second embodiment may be the image formation lens IL (2) shown in FIG. 5, the image formation lens IL (3) shown in FIG. 9, the image formation lens IL (4) shown in FIG. 13, or the image formation lens IL (5) shown in FIG. 17.

The conditional expression (5) appropriately defines anomalous dispersion characteristics of the negative lens. By satisfying the conditional expression (5), a secondary spectrum of chromatic aberration of magnification can sufficiently be corrected.

When a corresponding value of the conditional expression (5) is out of the above range, it becomes difficult to correct the secondary spectrum of the chromatic aberration of magnification. The effect of the present embodiment can be made more reliable by setting an upper limit of the conditional expression (5) to −0.0005 and further to −0.001. It is also possible to set a lower limit of the conditional expression (5) to −0.05 and further to −0.025.

The conditional expression (6) defines an appropriate range of the Abbe number of the negative lens. By satisfying the conditional expression (6), primary chromatic aberration of magnification can sufficiently be corrected.

When a corresponding value of the conditional expression (6) is out of the above range, it becomes difficult to correct the primary chromatic aberration of magnification. The effect of the present embodiment can be made more reliable by setting an upper limit of the conditional expression (6) to 36.5, 36, and further to 35.5. The effect of the present embodiment can be made more reliable by setting a lower limit of the conditional expression (6) to 23.5, 24, and further to 24.5.

In the image formation lens IL according to the second embodiment, the negative lens may satisfy the following conditional expression (7):

$$ndN < 1 \text{.78} \qquad ( 7 )$$

where ndN: a refractive index of the negative lens to a d-line.

The conditional expression (7) defines an appropriate range of the refractive index of the negative lens to the d-line. By satisfying the conditional expression (7), curvature of field can be corrected sufficiently.

When a corresponding value of the conditional expression (7) exceeds an upper limit, the refractive index of the negative lens to the d-line increases and it is hard to sufficiently cancel the term relating to the positive lens in petzval sum, which makes it difficult to correct the curvature of field. The effect of the present embodiment can be made more reliable by setting the upper limit of the conditional expression (7) to 1.77 and further to 1.76. It is also possible to set a lower limit of the conditional expression (7) to 1.57 and further to 1.58.

In the image formation lens IL according to the second embodiment, the negative lens may satisfy the following conditional expression (8):

$$- 1.1 < fN / f < - 0.2 \qquad ( 8 )$$

where fN: a focal length of the negative lens, and
f: a focal length of the image formation lens IL.

The conditional expression (8) defines an appropriate relationship between the focal length of the negative lens and the focal length of the image formation lens IL. By satisfying the conditional expression (8), the curvature of field can be corrected sufficiently.

When a corresponding value of the conditional expression (8) exceeds an upper limit, the focal length of the negative lens decreases and the term relating to the positive lens in petzval sum is excessively canceled, which makes it difficult to correct the curvature of field. The effect of the present embodiment can be made more reliable by setting the upper limit of the conditional expression (8) to −0.22 and further to −0.24.

When a corresponding value of the conditional expression (8) falls below a lower limit, the focal length of the negative lens increases and it is hard to sufficiently cancel the term relating to the positive lens in petzval sum, which makes it difficult to correct the curvature of field. The effect of the present embodiment can be made more reliable by setting the lower limit of the conditional expression (8) to −1.05.

In the image formation lens IL according to the first embodiment, the negative lens may satisfy the above described conditional expression (5). By satisfying the conditional expression (5), the secondary spectrum of the chromatic aberration of magnification can sufficiently be corrected as in the case of the second embodiment. Here, the effect of the present embodiment can be made more reliable by setting an upper limit of the conditional expression (5) to −0.0005 and further to −0.001. It is also possible to set a lower limit of the conditional expression (5) to −0.05 and further to −0.025.

In the image formation lens IL according to the first embodiment, the negative lens may satisfy the following conditional expression (6). By satisfying the conditional expression (6), the primary chromatic aberration of magnification can sufficiently be corrected as in the case of the second embodiment. The effect of the present embodiment can be made more reliable by setting an upper limit of the conditional expression (6) to 36.5, 36, and further to 35.5. The effect of the present embodiment can be made more reliable by setting a lower limit of the conditional expression (6) to 23.5, 24, and further to 24.5.

In the image formation lens IL according to the first embodiment, the negative lens may satisfy the following conditional expression (7). By satisfying the conditional expression (7), the curvature of field can sufficiently be corrected as in the case of the second embodiment. Here, the effect of the present embodiment can be made more reliable by setting an upper limit of the conditional expression (7) to 1.77 and further to 1.76. It is also possible to set a lower limit of the conditional expression (7) to 1.57 and further to 1.58.

In the image formation lens IL according to the first embodiment, the negative lens may satisfy the following conditional expression (8). By satisfying the conditional expression (8), the curvature of field can sufficiently be corrected as in the case of the second embodiment. Here, the effect of the present embodiment can be made more reliable by setting an upper limit of the conditional expression (8) to −0.22 and further to −0.24. The effect of the present embodiment can be made more reliable by setting a lower limit of the conditional expression (8) to −1.05.

The image formation lenses IL according to the first embodiment and the second embodiment may satisfy the following conditional expression (9):

$$0.2 < Bf / TL < 0.6 \qquad ( 9 )$$

where Bf: a back focus of the image formation lens IL, and
TL: an entire length of the image formation lens IL.

The conditional expression (9) defines an appropriate relationship between the back focus of the image formation lens IL and the entire Length of the image formation lens IL. In each of the embodiments, the entire length of the image formation lens IL represents the distance on the optical axis from a lens surface of the objective lens closest to an image to an image surface I. By satisfying the conditional expression (9), optical elements such as prisms and half mirrors can be disposed on the object side of the image formation lens IL, which makes it possible to easily switch between microscopic observation using the microscope device as a confocal fluorescence microscope and microscopic observation using the microscope device as a stereomicroscope, for example.

When a corresponding value of the conditional expression (9) exceeds an upper limit, it is necessary to increase the refractive power of the positive lens and the refractive power of the negative lens to increase a telephoto ratio, which makes it difficult to correct the curvature of field and the coma aberration. The effect of each of the embodiments can be made more reliable by setting the upper limit of the conditional expression (9) to 0.55 and further to 0.5.

When the corresponding value of the conditional expression (9) falls below a lower limit, it becomes difficult to dispose optical elements such as prisms and half mirrors on the object side of the image formation lens IL. The effect of each of the embodiments can be made more reliable by setting the lower limit of the conditional expression (9) to 0.21 and further to 0.22.

The image formation lenses IL according to the first embodiment and the second embodiment may consist of a first lens group G1 having positive refractive power, a second lens group G2 having negative refractive power, and a third lens group G3 having the positive refractive power, the second lens group G2 may consist of a single lens component having the negative refractive power, and the third lens group G3 may consist of a single lens component having the positive refractive power. In each of the embodiments, the lens component indicates a single lens or a cemented lens. As a result, the lenses are symmetrically disposed, and therefore astigmatism can be corrected sufficiently.

The image formation lenses IL according to the first embodiment and the second embodiment may satisfy the following conditional expression (10):

$$0.45 < f 1 / f 3 < 2.4 \qquad ( 10 )$$

where f1: a focal length of the first lens group G1, and
f3: a focal length of the third lens group G3.

The conditional expression (10) defines an appropriate relationship between the focal length of the first lens group G1 and the focal length of the third lens group G3. By satisfying the conditional expression (10), the image formation lens IL can be downsized while the field of view can be widened and the number of apertures can be increased.

When a corresponding value of the conditional expression (10) exceeds an upper limit, the refracting power of the third lens group G3 becomes too strong, which makes it undesirably difficult to downsize the image formation lens IL. The effect of each of the embodiments can be made more reliable by setting the upper limit of the conditional expression (10) to 2.35 and further to 2.3.

When the corresponding value of the conditional expression (10) falls below a lower limit, the refractive power of the first lens group G1 becomes too strong, which makes it difficult to correct the astigmatism, off-axis coma aberration, and distortion. The effect of each of the embodiments can be made more reliable by setting the lower limit of the conditional expression (10) to 0.48 and further to 0.50.

The image formation lenses IL according to the first embodiment and the second embodiment may satisfy the following conditional expression (11):

$$- 2.5 < f 1 / f 2 < - 0.6 \qquad ( 11 )$$

where f1: a focal length of the first lens group G1, and
f2: a focal length of the second lens group G2.

The conditional expression (11) defines an appropriate relationship between the focal length of the first lens group G1 and the focal length of the second lens group G2. By satisfying the conditional expression (11), the image formation lenses IL can be downsized while the field of view can be widened and the number of apertures can be expanded.

When a corresponding value of the conditional expression (11) exceeds an upper limit, the refracting power of the second lens group G2 becomes too weak, which makes it undesirably difficult to downsize the image formation lens IL. The effect of each of the embodiments can be made more reliable by setting the upper limit of the conditional expression (11) to −0.7 and further to −0.8.

When the corresponding value of the conditional expression (11) falls below a lower limit, the refracting power of the second lens group G2 becomes too strong, which makes it difficult to correct the curvature of field and the coma aberration. The effect of each of the embodiments can be made more reliable by setting the lower limit of the conditional expression (11) to −2.4 and further to −2.3.

In the microscope device (confocal fluorescence microscope 1) comprising the image formation lens IL according to the first embodiment or the second embodiment, the following conditional expression (12) may be satisfied:

$$0.3 < DA / TL < 0.6 \qquad ( 12 )$$

where DA: a distance on an optical axis from a lens surface of the objective lens closest to an image to a lens surface of the image formation lens IL closest to the object, and
TL: an entire length of the image formation lens IL.

The conditional expression (12) defines an appropriate relationship between the distance on the optical axis from the lens surface of the objective lens closest to the image to the lens surface of the image formation lens IL closest to the object and the entire Length of the image formation lens IL. By satisfying the conditional expression (12), optical elements such as prisms and half mirrors can be disposed on the object side of the image formation lens IL, which makes it possible to easily switch between microscopic observation using the microscope device as a confocal fluorescence microscope and microscopic observation using the microscope device as a stereomicroscope, for example.

When a corresponding value of the conditional expression (12) exceeds an upper limit, the diameter of each lens in the image formation lens IL increases, and it becomes difficult to secure a sufficient back focus. The effect of each of the embodiments can be made more reliable by setting the upper limit of the conditional expression (12) to 0.55, 0.5, and further to 0.48.

When the corresponding value of the conditional expression (12) falls below a lower limit, it becomes difficult to dispose optical elements such as prisms and half mirrors on the object side of the image formation lens IL. The effect of each of the embodiments can be made more reliable by setting the lower limit of the conditional expression (12) to 0.35 and further to 0.38.

In the microscope device (confocal fluorescence microscope 1) comprising the image formation lens IL according to the first embodiment or the second embodiment, the following conditional expression (13) may be satisfied:

$$0.1 < FDN / f < 0 \text{.18} \qquad ( 13 )$$

where FDN: a field number of the microscope device, and
f: a focal length of the image formation lens IL.

The conditional expression (13) defines an appropriate relationship between the field number of the microscope device and the focal length of the image formation lens IL. By satisfying the conditional expression (13), spherical aberration and coma aberration can be corrected sufficiently in a wide field of view.

When a corresponding value of the conditional expression (13) exceeds an upper limit, it becomes difficult to correct the spherical aberration and the coma aberration. The effect of each of the present embodiments can be made more reliable by setting the upper limit of the conditional expression (13) to 0.17.

When the corresponding value of the conditional expression (13) falls below a lower limit, sufficient magnification cannot be attained, which undesirably causes a narrower field of view. The effect of each of the present embodiments can be made more reliable by setting the lower limit of the conditional expression (13) to 0.11.

### EXAMPLES

Hereinafter, examples of the image formation lens IL according to each of the embodiments will be described based on the drawings. FIGS. 1, 5, 9, 13, and 17 are sectional views showing the configuration and refracting power distribution of the image formation lens IL {IL (1) to IL (5)} according to first to fifth examples. In FIGS. 1, 5, 9, 13, and 17, a combination of character G and numeral (or alphabet) denotes each lens group, and a combination of character L and numerical (or alphabet) denotes each lens. In this case, in order to prevent complication due to increase in type and number of the characters and numerals, combinations of characters and numerals that denote lens components or the like are used independently for each example. For this reason, even when an identical combination of character and numeral is used among the examples, it does not mean that the combination has an identical configuration.

Shown below are Table 1 to Table 5, in which Table 1 shows data for a first example, Table 2 shows data for a second example, Table 3 shows data for a third example, Table 4 shows data for a fourth example, and Table 5 shows data for a fifth example. In each example, the following calculation targets are selected for the aberration characteristics: the d-line (wavelength λ=587.6 nm); the C-line (wavelength λ=656.3 nm); the F-line (wavelength λ=486.1 nm); the g-line (wavelength λ=435.8 nm); and the s-line (wavelength λ=851.1 nm).

In the table of [General Data], f represents the focal length of the image formation lens. FNO represents an F number of the image formation lens. NA represents the numerical aperture of the image formation lens, and Bf represents the back focus of the image formation lens. TL represents the entire length of the image formation lens (distance on an optical axis from the lens surface of an objective lens closest to an image to the image surface). DA represents the distance on the optical axis from the lens surface of the objective lens closest to the image to the lens surface of the image formation lens closest to the object. FDN represents the field number of the microscope device.

In the table of [Lens Data], surface number represents the order of the lens surfaces from an object. R represents the radius of curvature of each optical surface (the surface having the center of curvature on the image surface side takes a positive value). D represents the surface distance that is the distance on the optical axis from each optical surface to the next optical surface (or to the image surface). vd represents the Abbe number based on the d-line of the material of an optical member. nd represents the refractive index of the material of an optical member to the d-line. θgF represents the partial dispersion ratio of the material of an optical member. Radius of curvature “∞” represents a surface or an aperture. Air refractive index nd=1.00000 is omitted.

Assume that ng is the refractive index of the material of an optical member to the g-line (wavelength λ=435.8 nm), nF is the refractive index of the material of the optical member to the F-line (wavelength λ=486.1 nm), and nC is the refractive index of the material of the optical member to the C-line (wavelength λ=656.3 nm). In this case, the partial dispersion ratio θgF of the material of the optical member is defined by the following expression (A).

$$θ gF = ( ng - nF ) / ( nF - nC ) \qquad ( A )$$

The table [Lens Group Data] shows the first surface (surface closest to an object) and the focal length of each lens group.

Hereinafter, in all the general data values, unless otherwise specified, the focal length f, the radius of curvature R, the surface distance D, other lengths, etc. are stated using a unit “mm” in most cases. However, the unit is not limited to “mm” since the optical systems can attain the same optical performance even when they are proportionally expanded or proportionally reduced.

The descriptions regarding the tables in the foregoing are the same for all the examples, and redundant description is omitted below.

### First Example

The first example will be described with reference to FIGS. 1 to 4 and Table 1. FIG. 1 is a sectional view showing the configuration of an image formation lens according to the first example. An image formation lens IL (1) according to the first example comprises, in order from an object on an optical axis, a first lens group G1 having positive refractive power, a second lens group G2 having negative refractive power, and a third lens group G3 having the positive refractive power. Note that the image formation lens IL (1) has an entrance pupil surface P corresponding to an exit pupil surface of an infinity correction type. An image surface I corresponds to the image formation surface 13 described before. These aspects are also true for all the following examples.

The first lens group G1 comprises, in order from an object on an optical axis, a biconvex positive lens L11, and a cemented lens formed by cementing a positive meniscus lens L12 having a convex surface facing the object, a biconvex positive lens L13, and a biconcave negative lens L14. The positive lens L13 of the cemented lens in the first lens group G1 corresponds to the positive lens that satisfies the aforementioned conditional expression (1) or the like.

The second lens group G2 comprises a negative meniscus lens L21 having a convex surface facing the object. The negative meniscus lens L21 in the second lens group G2 corresponds to the negative lens that satisfies the aforementioned conditional expression (5) or the like.

The third lens group G3 comprises a positive meniscus lens L31 having a convex surface facing the object. The image surface I is arranged on the image side of the third lens group G3.

Table 1 below shows data values of the image formation lens according to the first example. Here, the first surface is the entrance pupil surface P of the image formation lens.

TABLE 1
[General Data]

| | |
|---|---|
| f = 202.00 | FNO = 6.73 |
| NA = 0.07 | Bf = 88.65 |
| TL = 350.00 | DA = 160.00 |
| FDN = 25.00 | |

[Lens Data]

| Surface Number | R | D | nd | νd | θgF |
|---|---|---|---|---|---|
| 1 | ∞ | 160.00 | | | |
| 2 | 86.109 | 6.00 | 1.45600 | 91.37 | |
| 3 | −526.020 | 0.20 | | | |
| 4 | 56.104 | 4.67 | 1.49782 | 82.57 | |
| 5 | 100.000 | 6.00 | 1.66382 | 27.35 | 0.6319 |
| 6 | −200.000 | 8.10 | 1.73800 | 32.26 | |
| 7 | 105.381 | 9.30 | | | |
| 8 | 217.561 | 19.37 | 1.75575 | 24.71 | 0.6290 |
| 9 | 40.184 | 42.71 | | | |
| 10 | 103.799 | 5.00 | 1.85025 | 30.05 | |
| 11 | 317.656 | Bf | | | |

[Lens Group Data]

| Group | First Surface | Focal length |
|---|---|---|
| G1 | 2 | 95.68 |
| G2 | 8 | −68.43 |
| G3 | 10 | 179.41 |

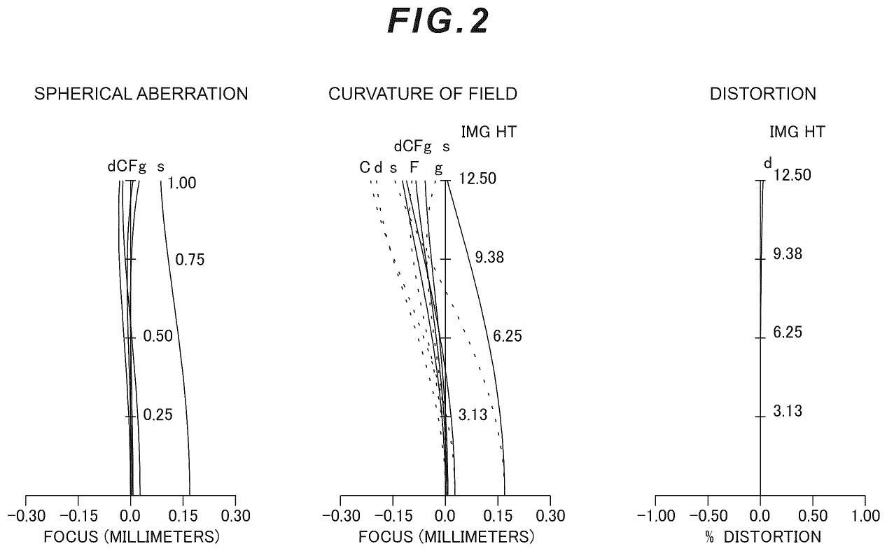

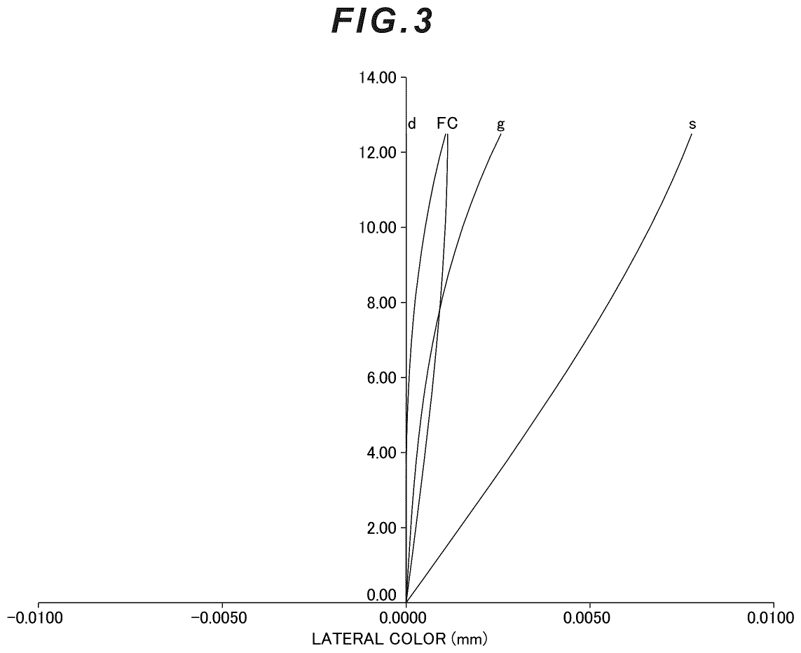

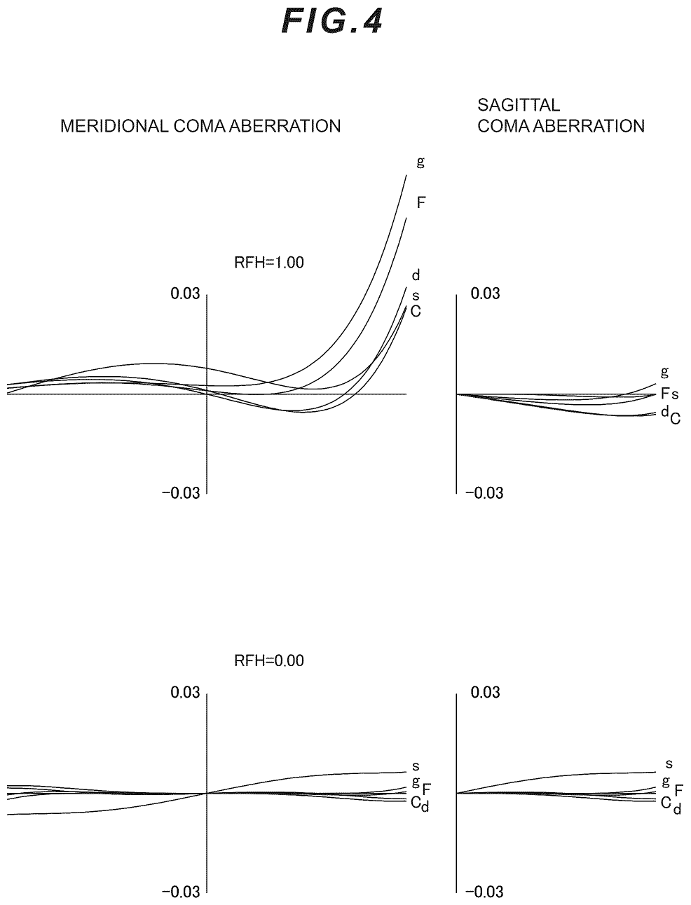

FIG. 2 shows various aberrations (spherical aberration, curvature of field, and distortion) of the image formation lens according to the first example. FIG. 3 shows the chromatic aberration of magnification (lateral chromatic aberration) of the image formation lens according to the first example. FIG. 4 shows the coma aberration (meridional coma aberration and sagittal coma aberration) of the image formation lens according to the first example. In each aberration diagram in FIGS. 2 to 4, d represents various aberrations relative to a d-line (wavelength λ=587.6 nm), C represents various aberrations relative to a C-line (wavelength λ=656.3 nm), F represents various aberrations relative to an F-line (wavelength 2=486.1 nm), g represents various aberrations relative to a g-line (wavelength λ=435.8 nm), and s represents various aberrations relative to an s-line (wavelength λ=851.1 nm). In the spherical aberration diagram, a vertical axis represents values obtained by normalizing a maximum value of the radius of the entrance pupil as 1, and a horizontal axis represents an aberration value for each ray. In the aberration diagram showing the curvature of field, solid lines represent sagittal image surfaces corresponding to respective wavelengths, and dashed lines represent meridional image surfaces corresponding to the respective wavelengths. In the aberration diagram showing the curvature of field, a vertical axis represents an image height [mm], and a horizontal axis represents an aberration value [mm]. In the distortion diagram (distortion), a vertical axis represents an image height [mm], and a horizontal axis represents an aberration rate by percentage (% value). In the aberration diagram showing the chromatic aberration of magnification, a vertical axis represents an image height [mm], and a horizontal axis represents an aberration value [mm]. Each of the coma aberration diagrams shows aberration values when relative field height (RFH) that is an image height ratio is 0.00 and 1.00. In the aberration diagram of each example shown below, the same characters as those used in this example are used, and redundant description is omitted.

As is clear from each of the aberration diagrams, various aberrations, including the chromatic aberration, of the image formation lens according to the first example are sufficiently corrected in a wide wavelength range, and the image formation lens has excellent optical performance.

### Second Example

The second example will be described with reference to FIGS. 5 to 8 and Table 2. FIG. 5 is a sectional view showing the configuration of an image formation lens according to the second example. An image formation lens IL (2) according to the second example comprises, in order from an object on an optical axis, a first lens group G1 having positive refractive power, a second lens group G2 having negative refractive power, and a third lens group G3 having the positive refractive power.

The first lens group G1 comprises, in order from an object on an optical axis, a biconvex positive lens L11, a positive meniscus lens L12 having a convex surface facing the object, a cemented lens formed by cementing a positive meniscus lens L13 having a convex surface facing the object and a negative meniscus lens L14 having a convex surface facing the object. The positive meniscus lens L13 of the cemented lens in the first lens group G1 corresponds to the positive lens that satisfies the aforementioned conditional expression (1) or the like.

The second lens group G2 comprises a biconcave negative lens L21. The negative lens L21 in the second lens group G2 corresponds to the negative lens that satisfies the aforementioned conditional expression (5) or the like.

The third lens group G3 comprises a biconvex positive lens L31. The image surface I is arranged on the image side of the third lens group G3.

Table 2 below shows data values of the image formation lens according to the second example. Here, the first surface is the entrance pupil surface P of the image formation lens.

TABLE 2
[General Data]

| | |
|---|---|
| f = 201.00 | FNO = 10.05 |
| NA = 0.05 | Bf = 109.11 |
| TL = 350.00 | DA = 150.00 |
| FDN = 32.00 | |

[Lens Data]

| Surface Number | R | D | nd | νd | θgF |
|---|---|---|---|---|---|
| 1 | ∞ | 150.00 | | | |
| 2 | 96.572 | 12.65 | 1.45600 | 91.37 | |
| 3 | −1109.978 | 26.76 | | | |
| 4 | 45.609 | 6.61 | 1.45600 | 91.37 | |
| 5 | 579.024 | 0.20 | | | |
| 6 | 40.424 | 4.01 | 1.61750 | 30.83 | 0.6231 |
| 7 | 61.797 | 3.00 | 1.73800 | 32.33 | |
| 8 | 30.170 | 6.82 | | | |
| 9 | −77.424 | 9.49 | 1.59270 | 35.27 | 0.5935 |
| 10 | 73.813 | 17.73 | | | |
| 11 | 2014.458 | 3.61 | 1.85025 | 30.05 | |
| 12 | −114.386 | Bf | | | |

[Lens Group Data]

| Group | First surface | Focal length |
|---|---|---|
| G1 | 2 | 103.23 |
| G2 | 9 | −62.30 |
| G3 | 11 | 127.40 |

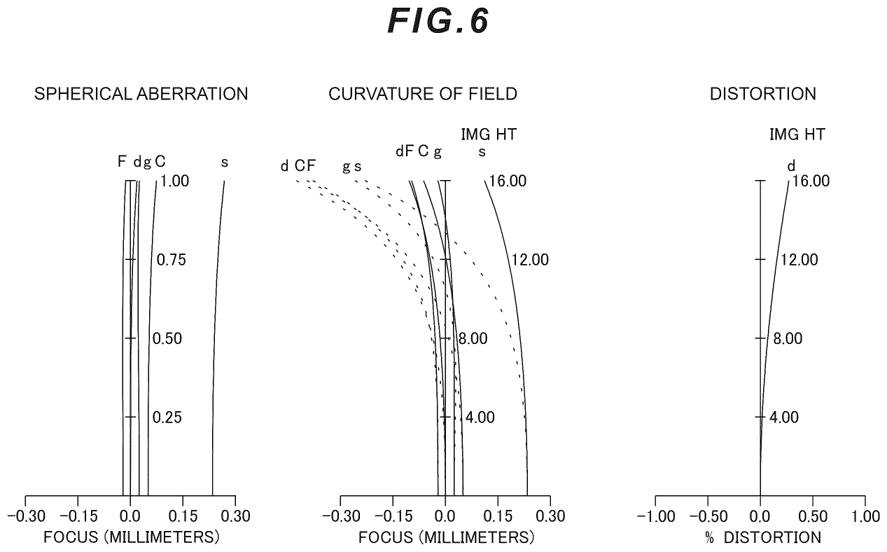

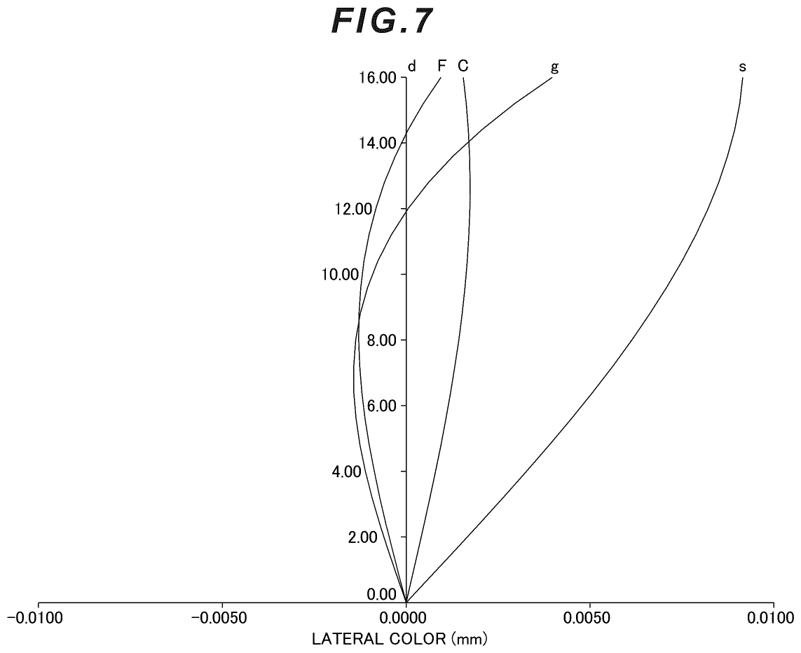

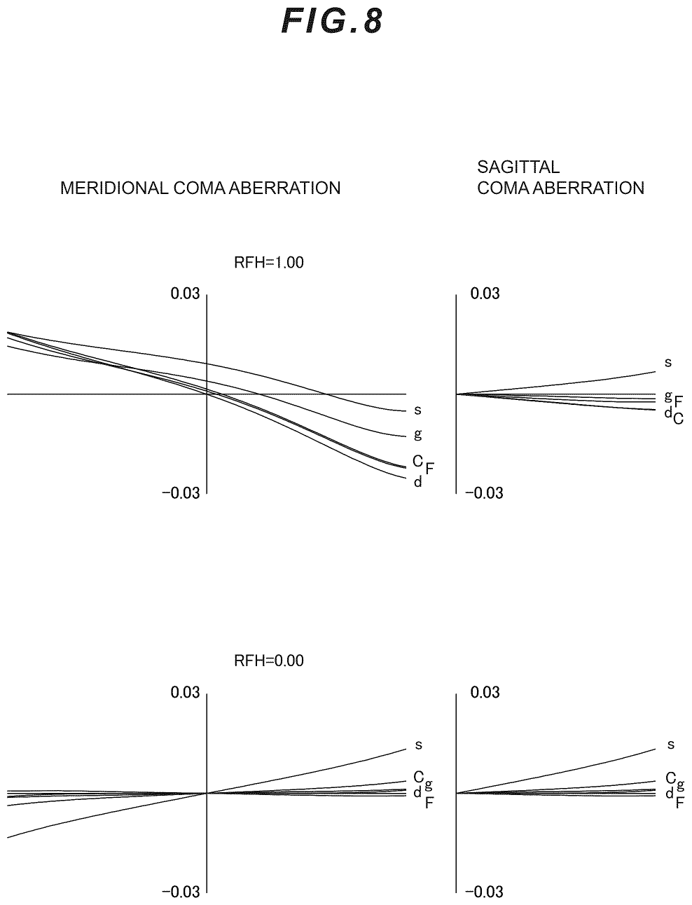

FIG. 6 shows various aberrations (spherical aberration, curvature of field, and distortion) of the image formation lens according to the second example. FIG. 7 shows the chromatic aberration of magnification (lateral chromatic aberration) of the image formation lens according to the second example. FIG. 8 shows the coma aberration (meridional coma aberration and sagittal coma aberration) of the image formation lens according to the second example. As is clear from each of the aberration diagrams, various aberrations, including the chromatic aberration, of the image formation lens according to the second example are sufficiently corrected in a wide wavelength range, and the image formation lens has excellent optical performance.

### Third Example

The third example will be described with reference to FIGS. 9 to 12 and Table 3. FIG. 9 is a sectional view showing the configuration of an image formation lens according to the third example. An image formation lens IL (3) according to the third example comprises, in order from an object on an optical axis, a first lens group G1 having positive refractive power, a second lens group G2 having negative refractive power, and a third lens group G3 having the positive refractive power.

The first lens group G1 comprises, in order from an object on an optical axis, a biconvex positive lens L11, and a positive meniscus lens L12 having a convex surface facing the object, and a cemented lens formed by cementing a biconvex positive lens L13 and a biconcave negative lens L14. The positive lens L13 of the cemented lens in the first lens group G1 corresponds to the positive lens that satisfies the aforementioned conditional expression (1) or the like.

The second lens group G2 comprises a biconcave negative lens L21. The negative lens L21 in the second lens group G2 corresponds to the negative lens that satisfies the aforementioned conditional expression (5) or the like.

The third lens group G3 comprises a biconvex positive lens L31. The image surface I is arranged on the image side of the third lens group G3.

Table 3 below shows data values of the image formation lens according to the third example. Here, the first surface is the entrance pupil surface P of the image formation lens.

TABLE 3
[General Data]

| | |
|---|---|
| f = 200.25 | FNO = 8.01 |
| NA = 0.06 | Bf = 100.00 |
| TL = 321.62 | DA = 130.00 |
| FDN = 32.00 | |

[Lens Data]

| Surface Number | R | D | nd | νd | θgF |
|---|---|---|---|---|---|
| 1 | ∞ | 130.00 | | | |
| 2 | 61.153 | 7.64 | 1.43425 | 94.77 | |
| 3 | −5880.256 | 0.30 | | | |
| 4 | 76.472 | 5.20 | 1.56908 | 71.34 | |
| 5 | 198.298 | 0.30 | | | |
| 6 | 111.442 | 7.19 | 1.66382 | 27.35 | 0.6319 |
| 7 | −112.886 | 3.00 | 1.73800 | 32.33 | |
| 8 | 115.027 | 20.21 | | | |
| 9 | −382.558 | 5.00 | 1.75575 | 24.71 | 0.6290 |
| 10 | 44.607 | 37.79 | | | |
| 11 | 141.268 | 5.00 | 1.85025 | 30.05 | |
| 12 | −449.497 | Bf | | | |

[Lens Group Data]

| Group | First surface | Focal length |
|---|---|---|
| G1 | 2 | 87.81 |
| G2 | 9 | −52.60 |
| G3 | 11 | 126.91 |

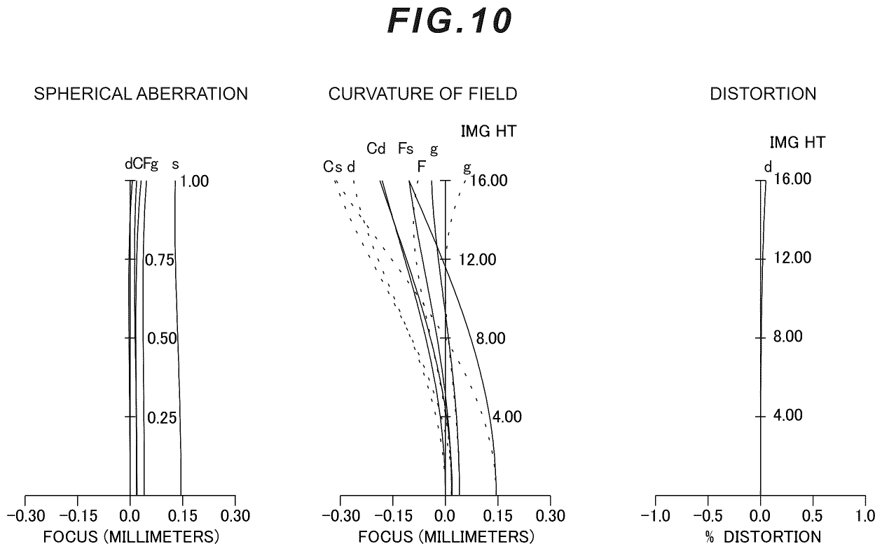

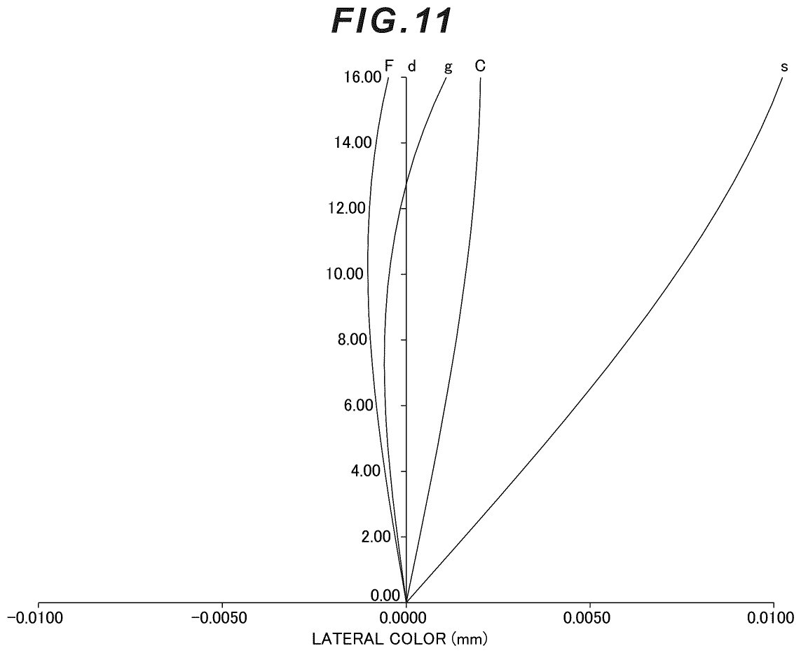

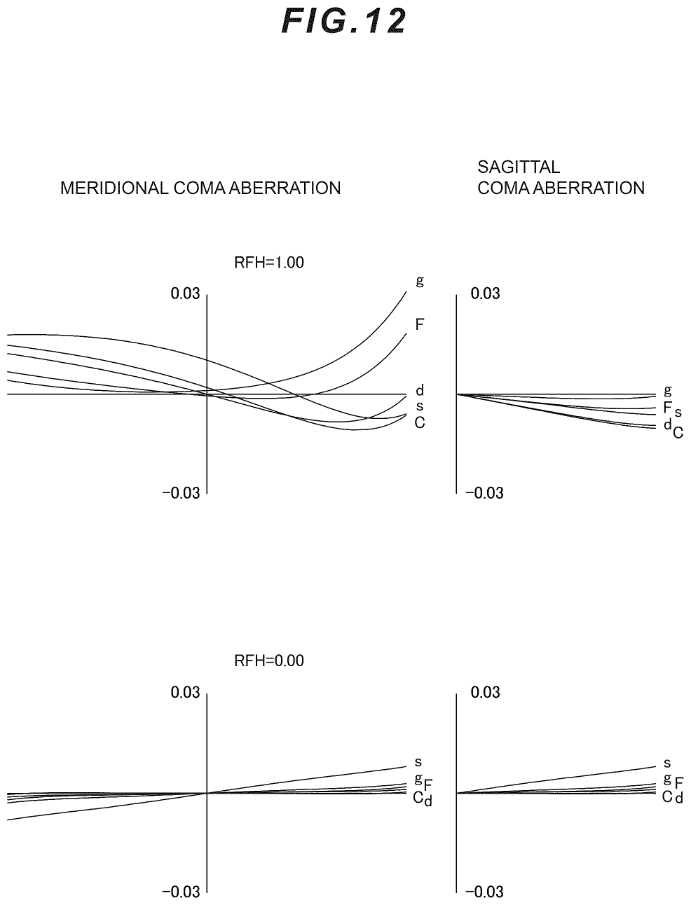

FIG. 10 shows various aberrations (spherical aberration, curvature of field, and distortion) of the image formation lens according to the third example. FIG. 11 shows the chromatic aberration of magnification (lateral chromatic aberration) of the image formation lens according to the third example. FIG. 12 shows the coma aberration (meridional coma aberration and sagittal coma aberration) of the image formation lens according to the third example. As is clear from each of the aberration diagrams, various aberrations, including the chromatic aberration, of the image formation lens according to the third example are sufficiently corrected in a wide wavelength range, and the image formation lens has excellent optical performance.

### Fourth Example

The fourth example will be described with reference to FIGS. 13 to 16 and Table 4. FIG. 13 is a sectional view showing the configuration of an image formation lens according to the fourth example. An image formation lens IL (4) according to the fourth example comprises, in order from an object on an optical axis, a first lens group G1 having positive refractive power, a second lens group G2 having negative refractive power, and a third lens group G3 having the positive refractive power.

The first lens group G1 comprises, in order from an object on an optical axis, a biconvex positive lens L11, and a positive meniscus lens L12 having a convex surface facing the object, and a cemented lens formed by cementing a positive meniscus lens L13 having a concave surface facing the object and a biconcave negative lens L14. The positive meniscus lens L13 of the cemented lens in the first lens group G1 corresponds to the positive lens that satisfies the aforementioned conditional expression (1) or the like.

The second lens group G2 comprises a negative meniscus lens L21 having a convex surface facing the object. The negative meniscus lens L21 in the second lens group G2 corresponds to the negative lens that satisfies the aforementioned conditional expression (5) or the like.

The third lens group G3 comprises a positive meniscus lens L31 having a convex surface facing the object. The image surface I is arranged on the image side of the third lens group G3.

Table 4 below shows data values of the image formation lens according to the fourth example. Here, the first surface is the entrance pupil surface P of the image formation lens.

TABLE 4
[General Data]

| | |
|---|---|
| f = 200.50 | FNO = 6.68 |
| NA = 0.07 | Bf = 80.00 |
| TL = 348.66 | DA = 160.00 |
| FDN = 25.00 | |

[Lens Data]

| Surface Number | R | D | nd | νd | θgF |
|---|---|---|---|---|---|
| 1 | ∞ | 160.00 | | | |
| 2 | 78.259 | 10.55 | 1.45600 | 91.37 | |
| 3 | −286.156 | 0.30 | | | |
| 4 | 65.866 | 6.60 | 1.45600 | 91.37 | |
| 5 | 286.969 | 6.00 | | | |
| 6 | −573.131 | 4.65 | 1.66382 | 27.35 | 0.6319 |
| 7 | −114.403 | 10.82 | 1.67300 | 38.26 | |
| 8 | 75.339 | 37.67 | | | |
| 9 | 63.694 | 4.64 | 1.61750 | 30.83 | 0.6231 |
| 10 | 41.142 | 22.43 | | | |
| 11 | 76.078 | 5.00 | 1.85025 | 30.05 | |
| 12 | 130.046 | Bf | | | |

[Lens Group Data]

| Group | First surface | Focal length |
|---|---|---|
| G1 | 2 | 192.28 |
| G2 | 9 | −204.21 |
| G3 | 11 | 206.81 |

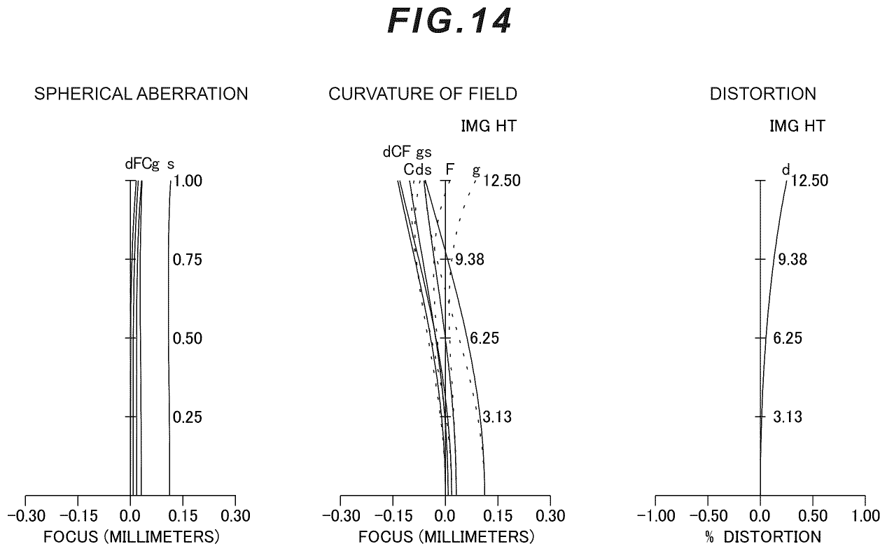

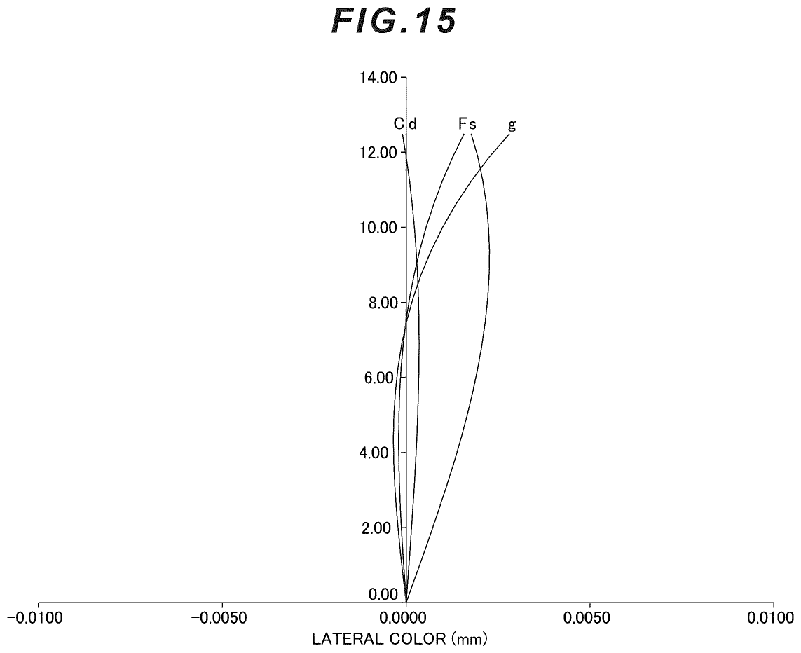

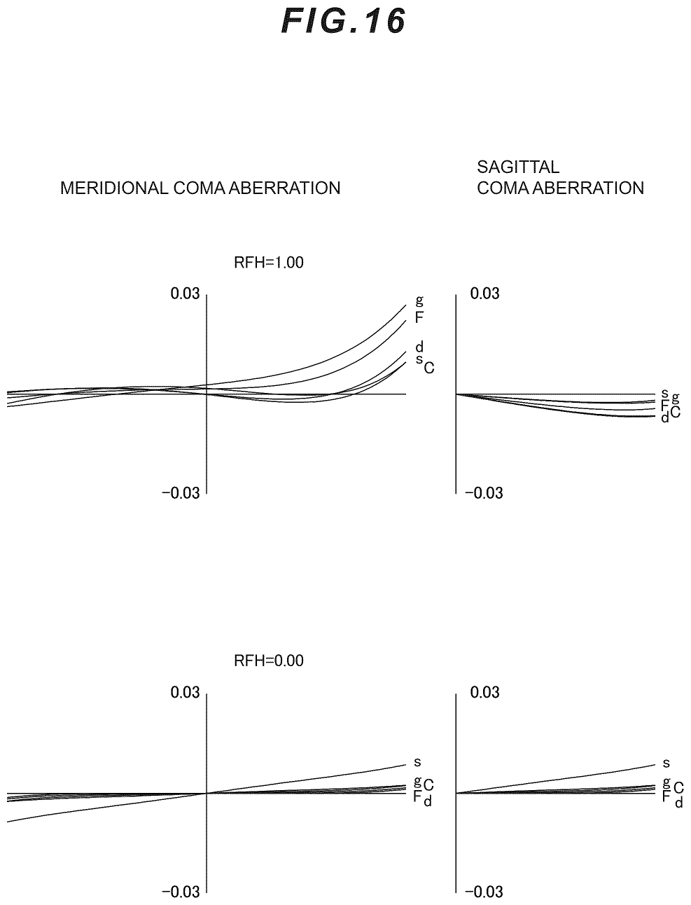

FIG. 14 shows various aberrations (spherical aberration, curvature of field, and distortion) of the image formation lens according to the fourth example. FIG. 15 shows the chromatic aberration of magnification (lateral chromatic aberration) of the image formation lens according to the fourth example. FIG. 16 shows the coma aberration (meridional coma aberration and sagittal coma aberration) of the image formation lens according to the fourth example. As is clear from each of the aberration diagrams, various aberrations, including the chromatic aberration, of the image formation lens according to the fourth example are sufficiently corrected in a wide wavelength range, and the image formation lens has excellent optical performance.

### Fifth Example

The fifth example will be described with reference to FIGS. 17 to 20 and Table 5. FIG. 17 is a sectional view showing the configuration of an image formation lens according to the fifth example. An image formation lens IL (5) according to the fifth example comprises, in order from an object on an optical axis, a first lens group G1 having positive refractive power, a second lens group G2 having negative refractive power, and a third lens group G3 having the positive refractive power.

The first lens group G1 comprises, in order from an object on an optical axis, a biconvex positive lens L11, and a positive meniscus lens L12 having a convex surface facing the object, and a cemented lens formed by cementing a positive meniscus lens L13 having a concave surface facing the object and a biconcave negative lens L14. The positive meniscus lens L13 of the cemented lens in the first lens group G1 corresponds to the positive lens that satisfies the aforementioned conditional expression (1) or the like.

The second lens group G2 comprises a negative meniscus lens L21 having a convex surface facing the object. The negative meniscus lens L21 in the second lens group G2 corresponds to the negative lens that satisfies the aforementioned conditional expression (5) or the like.

The third lens group G3 comprises a biconvex positive lens L31. The image surface I is arranged on the image side of the third lens group G3.

Table 5 below shows data values of the image formation lens according to the fifth example. Here, the first surface is the entrance pupil surface P of the image formation lens.

TABLE 5
[General Data]

| | |
|---|---|
| f = 200.25 | FNO = 8.01 |
| NA = 0.06 | Bf = 149.89 |
| TL = 327.69 | DA = 140.00 |
| FDN = 25.00 | |

[Lens Data]

| Surface Number | R | D | nd | νd | θgF |
|---|---|---|---|---|---|
| 1 | ∞ | 140.00 | | | |
| 2 | 50.458 | 7.00 | 1.45600 | 91.37 | |
| 3 | −1015.705 | 0.30 | | | |
| 4 | 50.531 | 5.00 | 1.45600 | 91.37 | |
| 5 | 242.282 | 3.00 | | | |
| 6 | −418.199 | 4.50 | 1.75575 | 24.71 | 0.6290 |
| 7 | −78.557 | 3.00 | 1.67300 | 38.26 | |
| 8 | 48.197 | 4.00 | | | |
| 9 | 2824.698 | 4.00 | 1.61750 | 30.83 | 0.6231 |
| 10 | 56.230 | 3.00 | | | |
| 11 | 117.967 | 4.00 | 1.85025 | 30.05 | |
| 12 | −236.827 | Bf | | | |

[Lens Group Data]

| Group | First surface | Focal length |
|---|---|---|
| G1 | 2 | 204.84 |
| G2 | 9 | −92.96 |
| G3 | 11 | 93.10 |

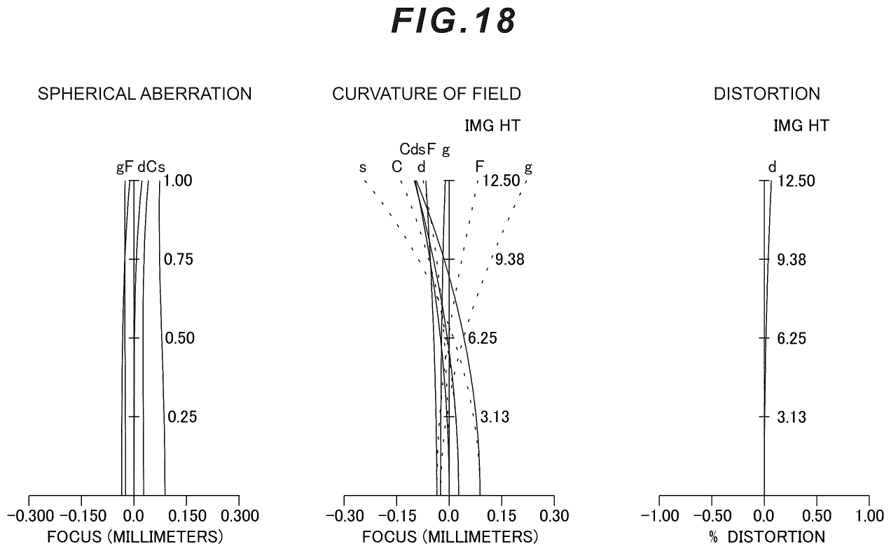

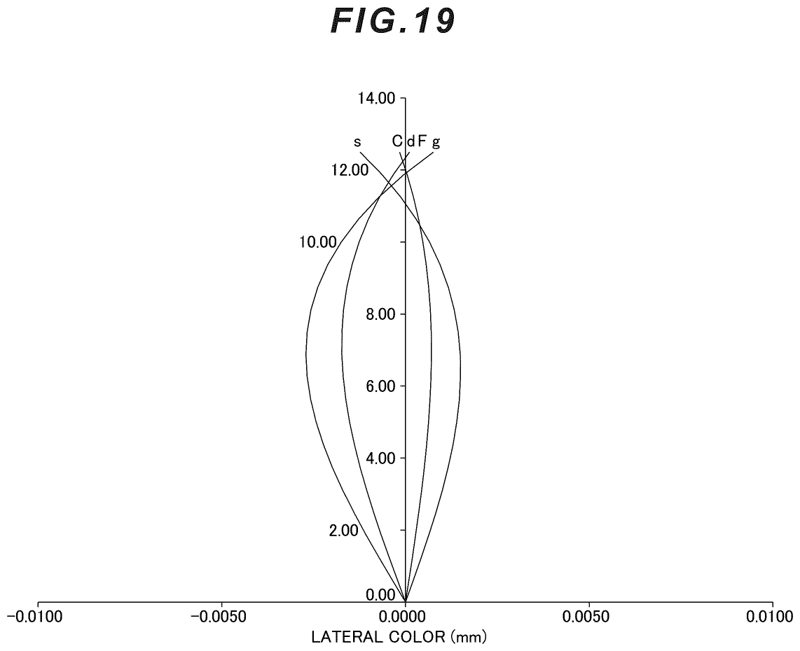

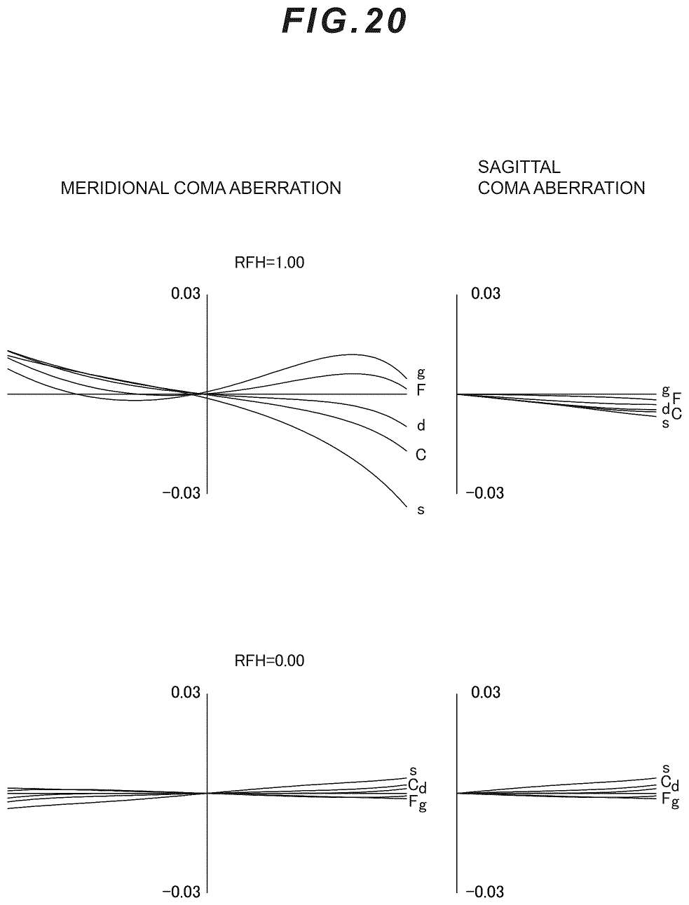

FIG. 18 shows various aberrations (spherical aberration, curvature of field, and distortion) of the image formation lens according to the fifth example. FIG. 19 shows the chromatic aberration of magnification (lateral chromatic aberration) of the image formation lens according to the fifth example. FIG. 20 shows the coma aberration (meridional coma aberration and sagittal coma aberration) of the image formation lens according to the fifth example. As is clear from each of the aberration diagrams, various aberrations, including the chromatic aberration, of the image formation lens according to the fifth example are sufficiently corrected in a wide wavelength range, and the image formation lens has excellent optical performance. NOW, the table of [Conditional Expression Corresponding Value] is shown below. In the table, the values corresponding to each of the conditional expressions (1) to (13) are summarized for all the examples (the first to fifth examples).

$$- 0.002 \times ( ν dP - 35 ) + 0.602 - θ gFP < 0 \qquad Conditional expression ( 1 )$$

$$23 < ν dP < 65 \qquad Conditional expression ( 2 )$$

$$1.55 < ndP < 1.79 \qquad Conditional expression ( 3 )$$

$$0.4 < fP / f < 1.2 \qquad Conditional expression ( 4 )$$

$$- 0.0033 \times ( ν dN - 35 ) + 0.593 - θ gFN < 0 \qquad Conditional expression ( 5 )$$

$$20 < ν dN < 37 \qquad Conditional expression ( 6 )$$

$$ndN < 1.78 \qquad Conditional expression ( 7 )$$

$$- 1.1 < fN / f < - 0.2 \qquad Conditional expression ( 8 )$$

$$0.2 < Bf / TL < 0.6 \qquad Conditional expression ( 9 )$$

$$0.45 < f 1 / f 3 < 2.4 \qquad Conditional expression ( 10 )$$

$$- 2.5 < f 1 / f 2 < - 0.6 \qquad Conditional expression ( 11 )$$

$$0.3 < DA / TL < 0.6 \qquad Conditional expression ( 12 )$$

$$0.1 < FDN / f < 0.18 \qquad Conditional expression ( 13 )$$

TABLE 6
[Conditional Expression Corresponding
Value] (first to third example)

| Conditional | First | Second | Third |
|---|---|---|---|
| Expression | example | example | example |
| (1) | −0.0146 | −0.0128 | −0.0146 |
| (2) | 27.35 | 30.83 | 27.35 |
| (3) | 1.6638 | 1.6175 | 1.6638 |
| (4) | 0.50 | 0.88 | 0.43 |
| (5) | −0.0020 | −0.0014 | −0.0020 |
| (6) | 24.71 | 35.27 | 24.71 |
| (7) | 1.7558 | 1.5927 | 1.7558 |
| (8) | −0.34 | −0.31 | −0.26 |
| (9) | 0.25 | 0.31 | 0.31 |
| (10) | 0.53 | 0.81 | 0.69 |
| (11) | −1.40 | −1.66 | −1.67 |
| (12) | 0.46 | 0.43 | 0.40 |
| (13) | 0.12 | 0.16 | 0.16 |

TABLE 7
[Conditional Expression Corresponding
Value] (fourth to fifth example)

| Conditional | Fourth | Fifth |
|---|---|---|
| Expression | example | example |
| (1) | −0.0146 | −0.0064 |
| (2) | 27.35 | 24.71 |
| (3) | 1.6638 | 1.7558 |
| (4) | 1.07 | 0.64 |
| (5) | −0.0163 | −0.0163 |
| (6) | 30.83 | 30.83 |
| (7) | 1.6175 | 1.6175 |
| (8) | −1.02 | −0.46 |
| (9) | 0.23 | 0.46 |
| (10) | 0.93 | 2.20 |
| (11) | −0.94 | −2.20 |
| (12) | 0.46 | 0.43 |
| (13) | 0.12 | 0.12 |

According to each of the above examples, it becomes possible to implement an image formation lens having chromatic aberration sufficiently corrected in a wide wavelength range and a microscope device comprising the image formation lens.

Here, the examples each show a specific example of the embodiments, and the present embodiment is not limited to these.

In each of the above examples, although the second lens group G2 comprises a single lens having negative refractive power, the second lens group G2 is not limited to this and may comprise a single cemented lens having negative refractive power. Although the third lens group G3 comprises a single lens having positive refractive power, the third lens group G3 is not limited to this and may comprise a single cemented lens having positive refractive power.

In each of the above examples, although the single positive lens (L13) in the image formation lens IL corresponds to the positive lens that satisfies the aforementioned conditional expression (1) or the like, the present invention is not limited to this, and a plurality of positive lenses in the image formation lens IL may correspond to the positive lens that satisfies the aforementioned conditional expression (1) or the like.

### EXPLANATION OF NUMERALS AND CHARACTERS

G1 First lens group
G2 Second lens group
G3 Third lens group
I Image surface
P Entrance pupil surface

1. An image formation lens for a microscope that forms an image of light from an objective lens, comprising:
a negative lens; and
a positive lens that satisfies the following conditional expression:
$$- 0.002 \times ( ν dP - 35 ) + 0.602 - θ gFP < 0$$
$$23 < ν dP < 65$$
where vdP: an Abbe number of the positive lens, and
θgFP: a partial dispersion ratio of the positive lens that is defined by the following expression:
$$θ gFP = ( ngP - nFP ) / ( nFP - nCP )$$
where ngP is a refractive index of the positive lens to a g-line, nFP is a refractive index of the positive lens to an F-line, and nCP is a refractive index of the positive lens to a C-line.

2. An image formation lens for a microscope that forms an image of light from an objective lens, comprising:
a positive lens; and
a negative lens that satisfies the following conditional expression:
$$- 0.0033 \times ( ν dN - 35 ) + 0.593 - θ gFN < 0$$
$$20 < ν dN < 37$$
where vdN: an Abbe number of the negative lens, and
θgFN: a partial dispersion ratio of the negative lens that is defined by the following expression:
$$θ gFN = ( ngN - nFN ) / ( nFN - nCN )$$
where ngN is a refractive index of the negative lens to a g-line, nFN is a refractive index of the negative lens to an F-line, and nCN is a refractive index of the negative lens to a C-line.

3. The image formation lens according to claim 1, wherein the positive lens satisfies the following conditional expression:
$$1.55 < ndP < 1.79$$
where ndP: a refractive index of the positive lens to the d-line.

4. The image formation lens according to claim 2, wherein the negative lens satisfies the following conditional expression:
ndN<1.78
where ndN: a refractive index of the negative lens to a d-line.

5. The image formation lens according to claim 1, wherein the positive lens satisfies the following conditional expression:
$$0.4 < fP / f < 1.2$$
where fP: a focal length of the positive lens, and
f: a focal length of the image formation lens.

6. The image formation lens according to claim 2, wherein the negative lens satisfies the following conditional expression:
$$- 1.1 < fN / f < - 0.2$$
where fN: a focal length of the negative lens, and
f: a focal length of the image formation lens.

7. The image formation lens according to claim 1, wherein the following conditional expression is satisfied:
$$0.2 < Bf / TL < 0.6$$
where Bf: a back focus of the image formation lens, and
TL: an entire length of the image formation lens.

8. The image formation lens according to claim 1, consisting of:
a first lens group having positive refractive power;
a second lens group having negative refractive power; and
a third lens group having the positive refractive power, wherein
the second lens group consists of a single lens component having the negative refractive power, and
the third lens group consists of a single lens component having the positive refractive power.

9. The image formation lens according to claim 8, wherein
the following conditional expression is satisfied:
$$0.45 < f 1 / f 3 < 2.4$$
where f1: a focal length of the first lens group, and
f3: a focal length of the third lens group.

10. The image formation lens according to claim 8- or 9, wherein the following conditional expression is satisfied:
$$- 2.5 < f 1 / f 2 < - 0.6$$
wherein f1: a focal length of the first lens group, and
f2: a focal length of the second lens group.

11. A microscope device comprising:
an objective lens that receives light from an object and converts the light into a parallel light; and
the image formation lens according to claim 1.

12. The microscope device according to claim 11, wherein the following conditional expression is satisfied:
$$0.3 < DA / TL < 0.6$$
where DA: a distance on an optical axis from a lens surface of the objective lens closest to an image to a lens surface of the image formation lens closest to the object, and
TL: an entire length of the image formation lens.

13. The microscope device according to claim 11, wherein the following conditional expression is satisfied:
$$0.1 < FDN / f < 0.18$$
where FDN: a field number of the microscope device, and
f: a focal length of the image formation lens.

14. The image formation lens according to claim 1, wherein the positive lens that satisfies the conditional expression, is placed Npth from an object side and satisfies the following conditional expression:
$$Np - N / 2 ≦ 0$$
where N: a total number of lenses in the image formation lens

15. The image formation lens according to claim 2, wherein the negative lens that satisfies the conditional expression, is arranged at the most object side among the negative lenses.
